(19) United States
(12) Patent Application Publication
(10) Pub. No.: US 2026/0136131 A1
(43) Pub. Date: May 14, 2026

(54) ACOUSTIC OUTPUT DEVICES

(71) Applicant: SHENZHEN SHOKZ CO., LTD., Shenzhen (CN)

(72) Inventors: Guangyuan ZHU, Shenzhen (CN); Lei ZHANG, Shenzhen (CN); Xin QI, Shenzhen (CN)

(73) Assignee: SHENZHEN SHOKZ CO., LTD., Shenzhen (CN)

(21) Appl. No.: 19/428,355

(22) Filed: Dec. 22, 2025

Related U.S. Application Data
(63) Continuation of application No. PCT/CN2023/138879, filed on Dec. 14, 2023.

(30) Foreign Application Priority Data
Oct. 27, 2023 (CN) 202311427342.7

(51) Int. Cl. H04R 1/26; H04R 1/10

(52) U.S. Cl. CPC H04R 1/26; H04R 1/1075; H04R 2460/13

(57) ABSTRACT

An acoustic output device is provided. The acoustic output device includes a housing, a bone conduction vibrator, an air conduction vibrator, and signal processing module. The signal processing module is configured to respectively provide a first audio signal and a second audio signal to the bone conduction vibrator and the air conduction vibrator. The first audio signal and the second audio signal have a frequency-dividing point. The first audio signal includes components with frequencies above the frequency-dividing point. The second audio signal includes components with frequencies below the frequency-dividing point. The bone conduction vibrator has a first resonance peak at a first resonant frequency. The air conduction vibrator has a second resonance peak at a second resonant frequency. The frequency-dividing point is greater than the first resonant frequency and the second resonant frequency.

### CROSS-REFERENCE TO RELATED APPLICATIONS

This application is a continuation of International Patent Application No. PCT/CN2023/138879, filed on December 14, 2023, which claims priority to the Chinese Patent Application No. 202311427342.7, filed on October 27, 2023, the entire contents of each of which are hereby incorporated by reference.

### TECHNICAL FIELD

The present disclosure generally relates to a field of acoustic technology, and in particular to an acoustic output device.

### BACKGROUND

An acoustic output device combining bone conduction and air conduction uses an air conduction vibrator to mainly provide low frequencies and a bone conduction vibrator to mainly provide high frequencies, which can reduce the vibration sensation caused by the vibration of the bone conduction vibrator and improve user experience. The acoustic output device combining bone conduction and air conduction sets a frequency-dividing point for bone conduction and air conduction audio signals (i.e., electrical signals), so that the bone conduction vibrator and the air conduction vibrator respectively generate sound waves with different main operating frequency ranges. In practical applications, the bone conduction and air conduction audio signals may have a certain frequency overlap near the frequency-dividing point, resulting in an overlap between the bone-conducted sound wave and the air-conducted sound wave generated by the bone conduction vibrator and the air conduction vibrator. At this time, it may cause the bone-conducted and air-conducted acoustic waves to undergo anti-phase cancellation within the overlapping frequency range, thereby affecting the acoustic effect of the acoustic output device.

Therefore, it is necessary to provide an acoustic output device that can avoid adverse effects caused by the interaction of bone conduction and air conduction audio signals near the frequency-dividing point, so as to improve the acoustic effect of the acoustic output device.

### SUMMARY

One or more embodiments of the present disclosure provide an acoustic output device. The acoustic output device includes a housing. The acoustic output device includes a bone conduction vibrator. The bone conduction vibrator is configured to generate a bone-conducted sound wave. The bone-conducted sound wave is transmitted to a cochlea via the housing to generate sound. The acoustic output device includes an air conduction vibrator configured to generate an air-conducted sound wave. The air-conducted sound wave is transmitted to an ear via a sound guiding hole on the housing. The acoustic output device includes a signal processing module configured to respectively provide a first audio signal and a second audio signal to the bone conduction vibrator and the air conduction vibrator. The first audio signal and the second audio signal have a frequency-dividing point. The first audio signal includes components with frequencies above the frequency-dividing point. The second audio signal includes components with frequencies below the frequency-dividing point. The bone conduction vibrator has a first resonance peak at a first resonant frequency. The air conduction vibrator has a second resonance peak at a second resonant frequency. The frequency-dividing point is greater than the first resonant frequency and the second resonant frequency.

In some embodiments, the first resonant frequency is located between the second resonant frequency and the frequency-dividing point.

In some embodiments, a difference between the first resonant frequency and the frequency-dividing point and a difference between the second resonant frequency and the frequency-dividing point are each not less than 100 Hz.

In some embodiments, at the frequency-dividing point, a phase difference between the first audio signal and the second audio signal does not exceed 30°.

In some embodiments, the frequency-dividing point is not less than 300 Hz.

In some embodiments, the housing includes two sound guiding holes. The two sound guiding holes are configured to output the air-conducted sound wave. An amplitude difference between sounds radiated through the two sound guiding holes is less than 6 dB. A phase difference between the sounds radiated through the two sound guiding holes is in a range of 150°-210°.

In some embodiments, a difference between acoustic loads of the two sound guiding holes is less than 0.15.

In some embodiments, a ratio of surface acoustic loads of the two sound guiding holes is 0.5-3.5.

In some embodiments, the air conduction vibrator has a front cavity or a rear cavity. The front cavity or the rear cavity forms a third resonance peak having a third resonant frequency. The frequency-dividing point is less than the third resonant frequency.

In some embodiments, a difference between the third resonant frequency and the frequency-dividing point is not less than 500 Hz.

In some embodiments, the frequency-dividing point is not higher than 3000 Hz.

In some embodiments, the signal processing module performs high-pass filtering and low-pass filtering respectively on an electrical signal containing sound information to obtain the first audio signal and the second audio signal.

One or more embodiments of the present disclosure also provide an acoustic output device. The acoustic output device includes a housing. The acoustic output device includes a bone conduction vibrator configured to generate a bone-conducted sound wave. The bone-conducted sound wave is transmitted to a cochlea via the housing to generate sound. The acoustic output device includes an air conduction vibrator configured to generate an air-conducted sound wave. The air-conducted sound wave is transmitted to an ear via a sound guiding hole on the housing. The acoustic output device includes a signal processing module configured to respectively provide a first audio signal and a second audio signal to the bone conduction vibrator and the air conduction vibrator. The first audio signal and the second audio signal have a frequency-dividing point. The first audio signal includes components with frequencies above the frequency-dividing point. The second audio signal includes components with frequencies below the frequency-dividing point. The air conduction vibrator has a front cavity or a rear cavity. The front cavity or the rear cavity forms a third resonance peak having a third resonant frequency. The frequency-dividing point is less than the third resonant frequency.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram of an exemplary acoustic output device according to some embodiments of the present disclosure;

FIG. 2 is a schematic structural diagram of a connection portion between a core assembly and an ear hook assembly according to some embodiments of the present disclosure;

FIG. 3 is a schematic diagram of an exploded structure of the core assembly in FIG. 2;

FIG. 4 is a block diagram of an exemplary acoustic output device according to some embodiments of the present disclosure;

FIG. 5 is a block diagram of another exemplary acoustic output device according to some embodiments of the present disclosure;

FIG. 6 is a schematic diagram of frequency response curves and phase curves of a bone conduction vibrator and an air conduction vibrator according to some embodiments of the present disclosure;

FIG. 7 is a schematic diagram of a frequency-dividing point according to some embodiments of the present disclosure;

FIG. 8 is a schematic diagram of a cross-section of a core assembly along a B-B direction according to some embodiments of the present disclosure;

FIG. 9 is a schematic diagram of an exemplary sound field of a dipole according to some embodiments of the present disclosure;

FIG. 10 is a schematic diagram of an exemplary radiation directivity sound field of the acoustic output device according to some embodiments of the present disclosure; and

FIG. 11 is a schematic diagram of frequency response curves and phase curves of sound signals output from two sound guiding holes coupled to a front cavity and a rear cavity of an air conduction vibrator according to some embodiments of the present disclosure.

### DETAILED DESCRIPTION

In order to more clearly illustrate the technical solutions related to the embodiments of the present disclosure, a brief introduction of the drawings referred to in the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that “system,” “device,” “unit,” and/or “module” as used herein is a manner used to distinguish different components, elements, parts, sections, or assemblies at different levels. However, if other words serve the same purpose, the words may be replaced by other expressions.

As shown in the present disclosure and claims, the words “one,” “a,” “a kind,” and/or “the” are not especially singular but may include the plural unless the context expressly suggests otherwise. In general, the terms “comprise,” “comprises,” “comprising,” “include,” “includes,” and/or “including” merely prompt to include operations and elements that have been clearly identified, and these operations and elements do not constitute an exclusive listing. The methods or devices may also include other operations or elements.

In the description of the present disclosure, it should be understood that the terms "first,” "second,” "third,” "fourth,” etc., are only used for descriptive purposes, and should not be understood as indicating or implying relative importance or implicitly indicating the count of the indicated technical features. Thus, features defined by "first,” "second,” "third,” and "fourth" may explicitly or implicitly include at least one of the features. In the description of the present disclosure, the meaning of "a plurality of" is at least two, e.g., two, three, etc., unless otherwise explicitly and specifically defined.

In the present disclosure, unless otherwise explicitly specified and defined, terms such as "connect" and "fix" should be understood in a broad sense. For example, the term "connect" may refer to a fixed connection, a detachable connection, or an integral connection. It may be a mechanical connection or an electrical connection. It may be a direct connection or an indirect connection through an intermediate medium. It may be an internal connection between two elements or an interaction relationship between two elements, unless otherwise explicitly defined. For those of ordinary skill in the art, the specific meanings of the above terms in the present disclosure may be understood according to specific situations.

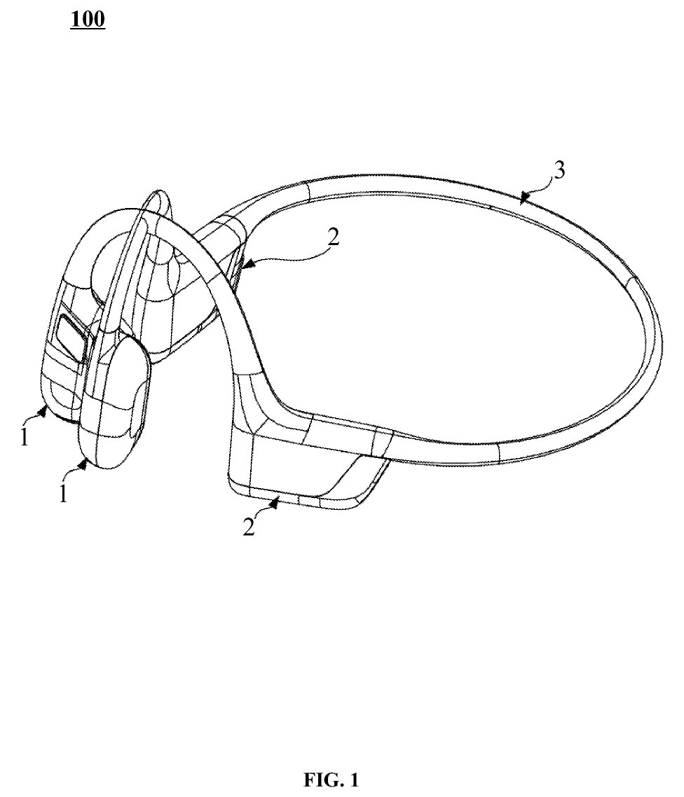

FIG. 1 is a schematic diagram of an exemplary acoustic output device according to some embodiments of the present disclosure.

Some embodiments of the present disclosure provide an acoustic output device 100. As shown in FIG. 1, the acoustic output device 100 may include a core assembly 1, an ear hook assembly 2, and a rear hook assembly 3. In some embodiments, a count of the core assembly 1 is two. The two core assemblies 1 are respectively configured to transmit vibrations and/or sounds to a left ear and a right ear of a user. The two core assemblies 1 may be the same or different. For example, one core assembly 1 may be provided with a microphone, and the other core assembly 1 may not be provided with a microphone. As another example, one core assembly 1 may be provided with a button and a corresponding circuit board, and the other core assembly 1 may not be provided with the button and the corresponding circuit board. The two core assemblies 1 may be the same in a core module (e.g., a speaker module). Hereinafter, one of the two core assemblies 1 will be taken as an example for a detailed description. A count of the ear hook assembly 2 may be two. The two ear hook assemblies 2 may be respectively hung on the left ear and the right ear of the user, so that the core assemblies 1 may fit the face of the user. Merely by way of example, a battery may be disposed at one ear hook assembly 2, and a control circuit or the like may be disposed at the other ear hook assembly 2. One end of the ear hook assembly 2 is connected to the core assembly 1, and the other end of the ear hook assembly 2 is connected to the rear hook assembly 3. The rear hook assembly 3 is connected to the two ear hook assemblies 2. The rear hook assembly 3 is configured to extend around a rear side of the neck or a rear side of the head of the user. The rear hook assembly 3 may provide a clamping force, so that the two core assemblies 1 are clamped on two sides of the face of the user, and the ear hook assembly 2 is more stably hung on the ear of the user.

It should be noted that, in some embodiments, the acoustic output device 100 may not include the rear hook assembly 3. In this case, the acoustic output device 100 may include one core assembly 1 and one ear hook assembly 2. One end of the ear hook assembly 2 may be connected to the core assembly 1, and the other end of the ear hook assembly 2 extends along a junction between the ear and the head of the user. In some embodiments, the ear hook assembly 2 may be an arc-shaped structure adapted to the auricle of the user, so that the ear hook assembly 2 is hung on the auricle of the user. For example, the ear hook assembly 2 may have an arc-shaped structure adapted to a junction between the head and the ear of the user, so that the ear hook assembly 2 may be hung between the auricle and the head of the user. In some embodiments, the ear hook assembly 2 may also be a clamping structure adapted to the auricle of the user, so that the ear hook assembly 2 may be clamped at the auricle of the user. Merely by way of example, the ear hook assembly 2 may include a hook portion and a connection portion connected in sequence. The connection portion connects the hook portion and the core assembly 1, so that the acoustic output device 100 is curved in a three-dimensional space when in a non-wearing state (i.e., a natural state). In other words, in the three-dimensional space, the hook portion, the connection portion, and the core assembly 1 are not coplanar. With such a configuration, when the acoustic output device 100 is in a wearing state, the hook portion is mainly used to be hung between a rear side of the ear and the head of the user, and the core assembly 1 is mainly used to contact a front side of the ear or the head of the user, thereby allowing the core assembly 1 and the hook portion to cooperate to clamp the ear. Merely by way of example, the connection portion may extend from the head to an outer side of the head, and cooperate with the hook portion to provide a pressing force on the front side of the ear for the core assembly 1. The core assembly 1 may press against the skin of the user under the action of the pressing force, so that the acoustic output device 100 does not block an external auditory canal of the ear when in the wearing state.

In some other embodiments, the acoustic output device 100 may not include the ear hook assembly 2 and the rear hook assembly 3, but include other fixing structures (not shown). The core assembly 1 is fixed on the fixing structure, so that the core assembly 1 is attached to the ear, the head, or other parts of the user through the fixing structure, thereby transmitting an air-conducted sound wave and/or a bone-conducted sound wave output by the core assembly 1 to the user. For example, the fixing structure may be a head-mounted structure. The head-mounted structure connects the left and right core assemblies 1 to form a head-mounted acoustic output device. As another example, the fixing structure is a bracket of eyeglasses, and the core assembly is fixed to the bracket of eyeglasses. As a further example, the fixing structure is an ear-clip structure, and the bone-conducted sound wave is transmitted by clamping the core assembly to the front or back of the auricle. As a further example, the fixing structure may also be a helmet, a mask, or other structures, which are not specifically limited herein.

For ease of understanding, exemplary structural schematic diagrams of the core assembly 1 of the acoustic output device 100 will be described below with reference to the accompanying drawings.

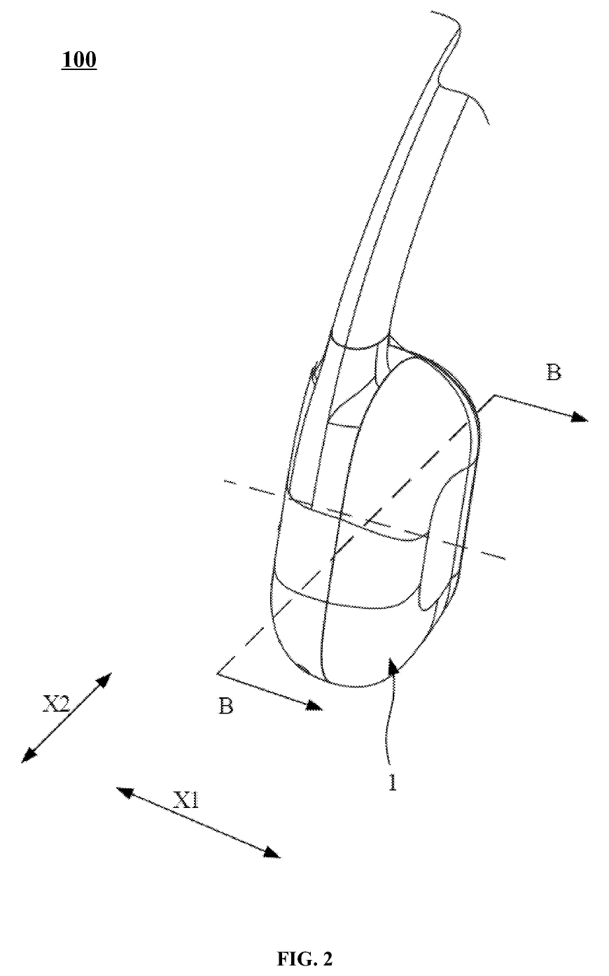

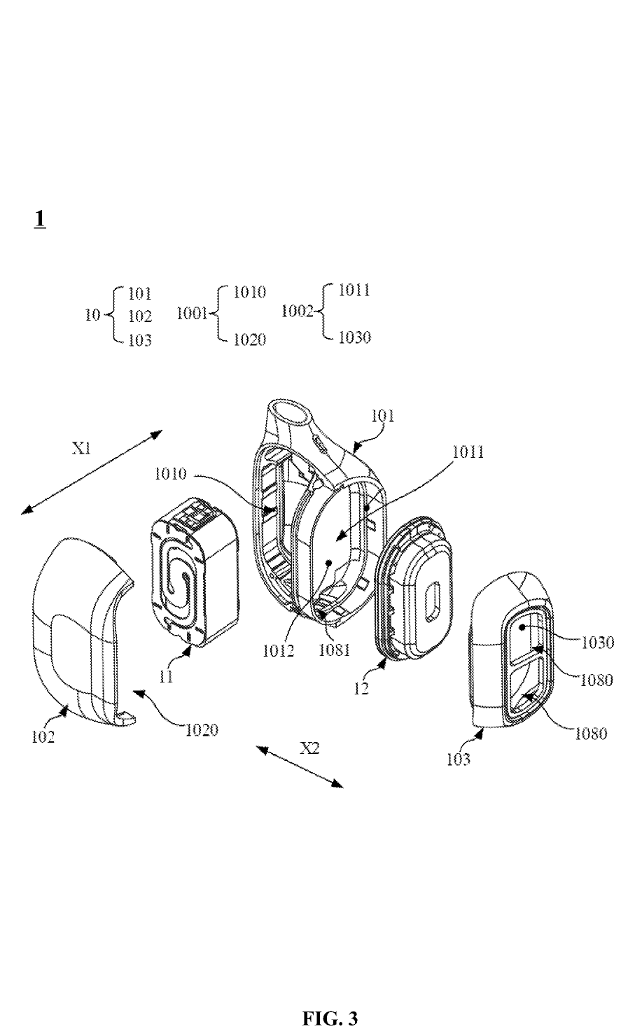

FIG. 2 is a schematic structural diagram of a connection portion between a core assembly and an ear hook assembly according to some embodiments of the present disclosure. FIG. 3 is a schematic diagram of an exploded structure of the core assembly in FIG. 2. As shown in FIG. 2 and FIG. 3, the core assembly 1 includes a housing 10, a bone conduction vibrator 11, and an air conduction vibrator 12.

In some embodiments, the housing 10 is provided with an accommodation cavity 1001 and an accommodation cavity 1002 that are isolated from each other. The bone conduction vibrator 11 is disposed in the accommodation cavity 1001. The air conduction vibrator 12 is disposed in the accommodation cavity 1002. The acoustic output device 100 operates through the combined work of the bone conduction vibrator 11 and the air conduction vibrator 12. The air conduction vibrator 12 is configured to generate air-conducted sound waves. The air-conducted sound wave is transmitted to an ear (or an ear canal) of the user via a sound guiding hole (e.g., a first sound guiding hole 1080 as shown in FIG. 3) on the housing 10, so that the user receives an air-conducted sound. The bone conduction vibrator 11 is configured to generate bone-conducted sound waves. The bone-conducted sound wave is transmitted to a cochlea of the user via the housing 10 to generate a bone-conducted sound. In some embodiments, the accommodation cavity 1001 is configured as a completely sealed accommodation cavity. In some embodiments, the accommodation cavity 1002 is configured as an accommodation cavity with relatively high sealing under the condition of ensuring the sound production of the air conduction vibrator 12. By the above manner, the bone conduction vibrator 11 and the air conduction vibrator 12 are independently disposed, which can effectively improve the sealing effect of the bone conduction vibrator 11, thereby preventing the bone conduction vibrator 11 from being eroded and damaged by external environmental factors, while ensuring the sound quality effect of the air conduction vibrator 12. In addition, when the acoustic output device 100 operates with both the bone conduction vibrator 11 and the air conduction vibrator 12 working simultaneously, the bone conduction vibrator 11 and the air conduction vibrator 12 are respectively disposed in the accommodation cavity 1001 and the accommodation cavity 1002. With such a configuration, mutual interference between the bone conduction vibrator 11 and the air conduction vibrator 12 (e.g., mutual interference between vibrations generated by the bone conduction vibrator 11 and the air conduction vibrator 12) may be effectively prevented, thereby effectively improving the sound quality of the acoustic output device 100.

Continuing to refer to FIG. 2 and FIG. 3, the housing 10 includes a first housing 101, a second housing 102, and a third housing 103. The housing 10 may be formed by the mutual cooperation of the first housing 101, the second housing 102, and the third housing 103. The first housing 101 and the second housing 102 cooperate to form the accommodation cavity 1001. The first housing 101 may be provided with a portion of the accommodation cavity 1002. The third housing 103 and the first housing 101 cooperate with each other to form another portion of the accommodation cavity 1002. The housing 10 is formed by the mutual cooperation of the first housing 101, the second housing 102, and the third housing 103 with the above structure, which can make the core assembly 1 structurally compact and also facilitate the assembly of the core assembly 1, thereby improving the assembly efficiency of the core assembly 1. In some embodiments, one portion of the accommodation cavity 1002 may also be disposed in the second housing 102, and the third housing 103 and the second housing 102 cooperate with each other to form another portion of the accommodation cavity 1002. Alternatively, the first housing 101 and the second housing 102 cooperate to form one portion of the accommodation cavity 1002, and the third housing 103, the first housing 101, and the second housing 102 cooperate with each other to collectively form another portion of the accommodation cavity 1002. The housing 10 implemented by any of the above manners can make the core assembly 1 structurally compact and also facilitate the assembly of the core assembly 1, thereby improving the assembly efficiency of the core assembly 1.

In some embodiments, the housing 10 is provided with a partition wall 1012 for isolating the accommodation cavity 1001 and the accommodation cavity 1002. The partition wall 1012 may be disposed on the first housing 101 and/or the second housing 102. Disposing the partition wall 1012 on the first housing 101 and/or the second housing 102 may be understood as the partition wall 1012 being a part of the first housing 101 and/or the second housing 102. Certainly, the manner of setting the partition wall 1012 is not limited to being disposed on the first housing 101 and/or the second housing 102. In other embodiments, the partition wall 1012 may also be an independent component from the first housing 101 and/or the second housing 102. In some embodiments, the partition wall 1012 is disposed on the first housing 101. The first housing 101 is provided with a sub-accommodation cavity 1010 and a sub-accommodation cavity 1011 located on opposite sides of the partition wall 1012. An opening direction of the sub-accommodation cavity 1010 is set along a wall surface of the partition wall 1012. An opening direction of the sub-accommodation cavity 1011 is arranged to intersect with the wall surface of the partition wall 1012. The second housing 102 is provided with a sub-accommodation cavity 1020. The second housing 102 covers an open end of the sub-accommodation cavity 1010. The sub-accommodation cavity 1020 and the sub-accommodation cavity 1010 cooperate to form the accommodation cavity 1001. The third housing 103 is provided with a sub-accommodation cavity 1030. The third housing 103 covers an open end of the sub-accommodation cavity 1011. The sub-accommodation cavity 1030 and the sub-accommodation cavity 1011 cooperate to form the accommodation cavity 1002.

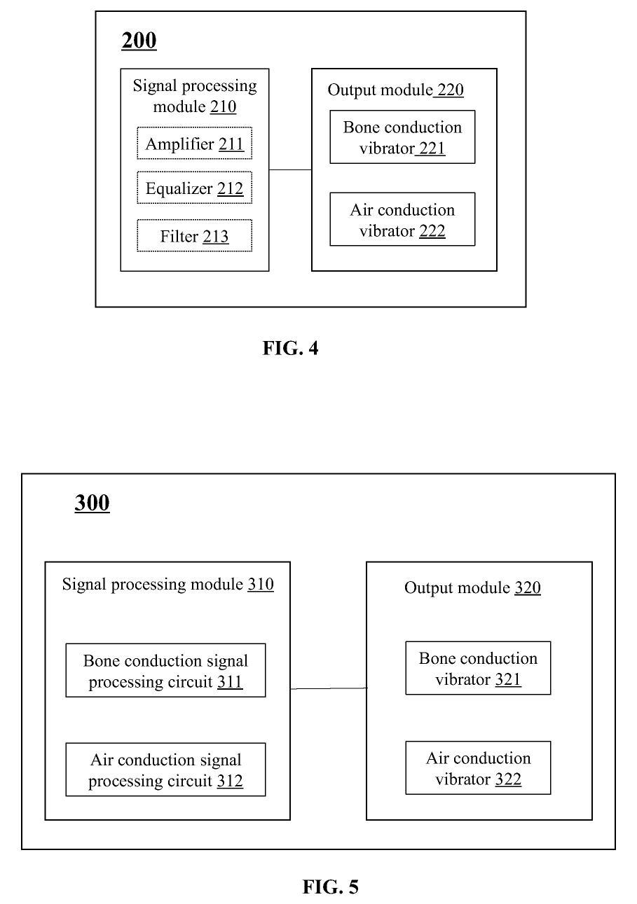

FIG. 4 is a block diagram of an exemplary acoustic output device according to some embodiments of the present disclosure. As shown in FIG. 4, an acoustic output device 200 may include a signal processing module 210 and an output module 220. The signal processing module 210 is configured to process an original audio signal. The original audio signal refers to an electrical signal containing sound information. In some embodiments, the original audio signal may include an audio signal stored internally in the acoustic output device 200 or in a device communicatively connected to the outside world, etc. For example, the original audio signal may be an electrical signal obtained from a multimedia platform, a terminal device, a storage device, etc.

The signal processing module 210 may process the original audio signal (i.e., the electrical signal) and transmit the processed signal to the output module 220. For example, the signal processing module 210 may process the original audio signal by performing various signal processing operations (e.g., sampling, digitizing, amplifying, compressing, frequency allocation, frequency modulation, filtering, encoding, etc.). The signal processing module 210 may further generate a first audio signal and a second audio signal based on the processed original audio signal and transmit the first audio signal and the second audio signal to the output module 220. As described herein, the first audio signal refers to an electrical signal related to a bone-conducted sound wave and/or an electrical signal that affects the generation and output of the bone-conducted sound wave. The second audio signal refers to an electrical signal related to an air-conducted sound wave and/or an electrical signal that affects the generation and output of the air-conducted sound wave. In some embodiments, both the first audio signal and the second audio signal are electrical signals that are ultimately input to coils in the bone conduction vibrator and the air conduction vibrator after processing (e.g., amplification, equalization, filtering, etc.).

The output module 220 may generate and output a bone-conducted sound wave (also referred to as bone-conducted sound) and/or an air-conducted sound wave (also referred to as air-conducted sound). The output module 220 may receive an audio signal (e.g., the processed first audio signal and the processed second audio signal) from the signal processing module 210 and generate a bone-conducted sound wave and/or an air-conducted sound wave based on the audio signal. As described herein, the bone-conducted sound wave refers to a sound wave conducted in the form of mechanical vibration through a solid medium (e.g., bone, tissue, etc.). The air-conducted sound wave refers to a sound wave conducted through air.

Specifically, the output module 220 may include a bone conduction vibrator (also referred to as a bone conduction speaker) 221 and an air conduction vibrator 222 (also referred to as an air conduction speaker). The bone conduction vibrator 221 and the air conduction vibrator 222 may be electrically coupled to the signal processing module 210. The bone conduction vibrator 221 may generate a bone-conducted sound wave in a specific frequency range (e.g., a low-frequency range, a mid-frequency range, a high-frequency range, a mid-low frequency range, a mid-high frequency range) according to the first audio signal generated by the signal processing module 210. The air conduction vibrator 222 may generate an air-conducted sound wave in the same or a different frequency range as the bone-conducted sound wave according to the second audio signal generated by the signal processing module 210. In some embodiments, the bone conduction vibrator 221 and the air conduction vibrator 222 may be two independent functional devices, or two independent components of a single device. As described herein, the air conduction vibrator is independent of the bone conduction vibrator because each of the two speakers is independently driven by an electrical signal to generate a sound wave.

Different frequency ranges may be determined according to actual needs. For example, the low-frequency range (also referred to as low frequency) may refer to a frequency range from 20 Hz to 150 Hz, the mid-frequency range (also referred to as mid frequency) may refer to a frequency range from 150 Hz to 5 kHz, the high-frequency range (also referred to as high frequency) may refer to a frequency range from 5 kHz to 20 kHz, the mid-low frequency range (also referred to as mid-low frequency) may refer to a frequency range from 150 Hz to 500 Hz, and the mid-high frequency range (also referred to as mid-high frequency) may refer to a frequency range from 500 Hz to 5 kHz. As another example, the low-frequency range may refer to a frequency range from 20 Hz to 200 Hz, the mid-frequency range may refer to a frequency range from 200 Hz to 3 kHz, the high-frequency range may refer to a frequency range from 3 kHz to 20 kHz, the mid-low frequency range may refer to a frequency range from 100 Hz to 1000 Hz, and the mid-high frequency range may refer to a frequency range from 1000 Hz to 10 kHz. It should be noted that the values of the frequency ranges are for illustrative purposes only and are not limiting. The definition of the above frequency ranges may vary according to different application scenarios and different classification criteria. As another example, in some other application scenarios, a low-frequency range may refer to a frequency range from 20 Hz to 80 Hz, a mid-frequency range may refer to a frequency range from 160 Hz to 1280 Hz, a high-frequency range may refer to a frequency range from 2560 Hz to 20 kHz, a mid-low frequency range may refer to a frequency range from 80 Hz to 160 Hz, and a mid-high frequency range may refer to a frequency range from 1280 Hz to 2560 Hz. Optionally, different frequency ranges may or may not have overlapping frequencies.

FIG. 5 is a block diagram of another exemplary acoustic output device according to some embodiments of the present disclosure. In some embodiments, the acoustic output device 300 shown in FIG. 5 may be similar to the acoustic output device 200 shown in FIG. 4, with the difference that the signal processing module 310 further includes a bone conduction signal processing circuit 311 and an air conduction signal processing circuit 312. The bone conduction signal processing circuit 311 may be configured to process and generate the first audio signal. The air conduction signal processing circuit 312 may be configured to process and generate the second audio signal.

In some embodiments, the bone conduction signal processing circuit 311 and the air conduction signal processing circuit 312 may respectively include an amplifier, an equalizer, a filter, etc. In some embodiments, the bone conduction signal processing circuit 311 and the air conduction signal processing circuit 312 may also share an amplifier, an equalizer, a filter, etc.

The output module 320 includes a bone conduction vibrator 321 and an air conduction vibrator 322. The bone conduction vibrator 321 and the air conduction vibrator 322 may be the same as or similar to the bone conduction vibrator 221 and the air conduction vibrator 222 of the output module 220 in FIG. 4, respectively, and are not repeated here. The bone conduction vibrator 321 may be electrically coupled to the bone conduction signal processing circuit 311. The bone conduction vibrator 321 may generate and output a bone-conducted sound wave in a specific frequency range according to the first audio signal generated by the bone conduction signal processing circuit 311. The air conduction vibrator 322 may be electrically coupled to the air conduction signal processing circuit 312. The air conduction vibrator 322 may generate and output the air-conducted sound wave in the same or different frequency range as the bone-conducted sound wave according to the second audio signal generated by the air conduction signal processing circuit 312.

In some embodiments, the bone conduction signal processing circuit 311 and the bone conduction vibrator 321 may be integrated or arranged in the same cavity (e.g., the accommodation cavity 1001). Similarly, the air conduction signal processing circuit 312 and the air conduction vibrator 322 may be integrated or arranged in the same cavity (e.g., the accommodation cavity 1002). In some embodiments, the bone conduction signal processing circuit 311 and the bone conduction vibrator 321 may be arranged in different cavities. For example, the bone conduction signal processing circuit 311 may be arranged in the ear hook assembly 2, and the bone conduction vibrator 321 may be arranged in the accommodation cavity 1001. Similarly, the air conduction signal processing circuit 312 and the air conduction vibrator 322 may be arranged in different cavities. For example, the air conduction signal processing circuit 312 may be arranged in the ear hook assembly 2, and the air conduction vibrator 322 may be arranged in the accommodation cavity 1002.

In some embodiments, the first audio signal and the second audio signal have a frequency-dividing point. In the present disclosure, the frequency-dividing point refers to an intersection point in a frequency domain of the first audio signal and the second audio signal output to the bone conduction vibrator and the air conduction vibrator after being processed by the signal processing module (e.g., the signal processing module 210, the signal processing module 310). The first audio signal includes a first frequency band (e.g., a mid-high frequency band). The first frequency band includes frequency components above the frequency-dividing point. The second audio signal includes a second frequency band (e.g., a mid-low frequency band). The second frequency band includes frequency components below the frequency-dividing point.

It should be noted that, in the present disclosure, the frequency-dividing point may be measured by the following manner: connecting leads in parallel to input terminals of the bone conduction vibrator and the air conduction vibrator from an output terminal of the signal processing module, and using a sound card and Audition software to record two sets of electrical signals and convert them into the frequency domain, an intersection point of curves corresponding to the two sets of electrical signals in the frequency domain is the frequency-dividing point.

In some embodiments, based on the frequency-dividing point, the signal processing module 310 may determine a component in the original audio signal within the first frequency band (i.e., the first audio signal) and a component in the original audio signal within the second frequency band (i.e., the second audio signal). The bone conduction vibrator 321 vibrates in response to the first audio signal to generate a bone-conducted sound wave in the first frequency band. The air conduction vibrator 322 vibrates in response to the second audio signal to generate an air-conducted sound wave in the second frequency band.

It should be noted that, because the air load pushed by the air conduction vibrator is small, outputting sound in the second frequency band (e.g., the mid-low frequency band) in the form of the air-conducted sound wave is beneficial for reducing the power consumption of the acoustic output device 100. Furthermore, when the frequency is within the second frequency band, sound leakage of the acoustic output device 100 is not easily received by a human ear, and thus has little impact on the listening experience and listening privacy of the user. In contrast, outputting sound in the first frequency band (e.g., the mid-high frequency band) in the form of the bone-conducted sound wave, which is transmitted to the cochlea of the user through the bones, tissues, etc., of the user, and rarely generates sound leakage. On this basis, even if the acoustic output of the acoustic output device 100 is increased, there will not be significant sound leakage. In addition, providing mid-high frequency sound output by the bone conduction vibrator can reduce the vibration sensation caused by the vibration of the bone conduction vibrator, thereby further improving the user experience.

With reference to FIG. 4 and FIG. 5, in order to adjust an output characteristic of the bone conduction vibrator and/or the air conduction vibrator (e.g., a frequency, a phase, an amplitude, etc., of the output bone-conducted sound wave and air-conducted sound wave), the original audio signal may be processed in the signal processing module 210 or the signal processing module 310 to obtain the first audio signal and/or the second audio signal, so that the bone conduction vibrator and/or the air conduction vibrator may have different output characteristics. For example, the first audio signal and/or the second audio signal may include a signal of a specific frequency range. In some alternative embodiments, a structure of at least one component in the output module 220 or the output module 320 may be modified or optimized, so that the output characteristic of the bone conduction vibrator and/or the air conduction vibrator (e.g., a frequency range of the output sound wave) may be adjusted.

In some embodiments, the signal processing module 210 or the signal processing module 310 may process the original audio signal through hardware, software (algorithm), or a combination thereof. For example, the signal processing module 210 may include an amplifier 211. The signal processing module 210 may amplify a certain signal (e.g., the original audio signal) through the amplifier 211 (or an amplification circuit) and/or an amplification algorithm. As another example, the signal processing module 210 may include an equalizer 212. The equalizer 212 is configured to perform equalization processing on the signal (e.g., the filtered original audio signal). As yet another example, the signal processing module 210 may include a filter 213. The filter 213 is configured to perform filtering processing on the original audio signal to obtain the first audio signal and the second audio signal, respectively. In some embodiments, the hardware may further include, but is not limited to, a dynamic range controller (DRC), a phase processor (GAIN), etc.

In some embodiments, the signal processing module 210 or the signal processing module 310 may process the original audio signal through one or more filters or filter banks to obtain the first audio signal and/or the second audio signal. Exemplary filters or filter banks may include, but are not limited to, an analog filter, a digital filter, a passive filter, an active filter, etc., or a combination thereof. For example, the signal processing module includes a high-pass filter and a low-pass filter. The signal processing module may perform high-pass filtering on the original audio signal to obtain the first audio signal, and perform low-pass filtering on the original audio signal to obtain the second audio signal.

In some embodiments, a cutoff frequency of the low-pass filter may be the same as a cutoff frequency of the high-pass filter. After the original audio signal is processed by the low-pass filter, a portion above the cutoff frequency (i.e., the frequency-dividing point) is filtered out, thereby mainly retaining low-frequency components (i.e., the second audio signal) below the cutoff frequency. Similarly, after the original audio signal is processed by the high-pass filter, a portion below the cutoff frequency (i.e., the frequency-dividing point) is filtered out, thereby mainly retaining high-frequency components (i.e., the first audio signal) above the cutoff frequency. In some embodiments, the cutoff frequency of the low-pass filter may be different from the cutoff frequency of the high-pass filter. In this case, the frequency-dividing point is the intersection point in the frequency domain of the first audio signal and the second audio signal output to the bone conduction vibrator and the air conduction vibrator.

It should be noted that, in practical applications, there may be a certain frequency overlap near the frequency-dividing point between the first audio signal and the second audio signal obtained through processing by the signal processing module 210 or the signal processing module 310. The frequency range of the bone-conducted sound wave generated by the bone conduction vibrator in response to the first audio signal corresponds to the frequency range of the first audio signal. The frequency range of the air-conducted sound wave generated by the air conduction vibrator in response to the second audio signal corresponds to the frequency range of the second audio signal. Therefore, it may cause the bone-conducted sound wave and the air-conducted sound wave generated by the bone conduction vibrator and the air conduction vibrator to overlap in a certain frequency band. That is, in this overlapping frequency band, both the air-conducted sound wave and the bone-conducted sound wave exist.

The bone-conducted sound wave and the air-conducted sound wave satisfy an acoustic characteristic of in-phase enhancement and out-of-phase cancellation at the cochlea. That is, sounds that are in phase or substantially in phase produce a superposition effect at the cochlea, which can improve the listening effect of the user. Conversely, sounds that are out of phase or substantially out of phase produce a cancellation effect at the cochlea, which can reduce the listening effect of the user. Therefore, in the embodiments of the present disclosure, in order to avoid the bone-conducted sound wave and the air-conducted sound wave producing a cancellation effect in the overlapping frequency band, which can reduce the listening effect of the user, the phase of the first audio signal and the phase of the second audio signal in the overlapping frequency portion may be controlled to be the same or substantially the same, so that the generated bone-conducted sound wave and air-conducted sound wave enhance each other through superposition at the cochlea of the user. This enables the acoustic output device to output strong sound in frequency bands to which the human ear is sensitive (e.g., 20 Hz-4000 Hz), thereby improving the listening effect of the user.

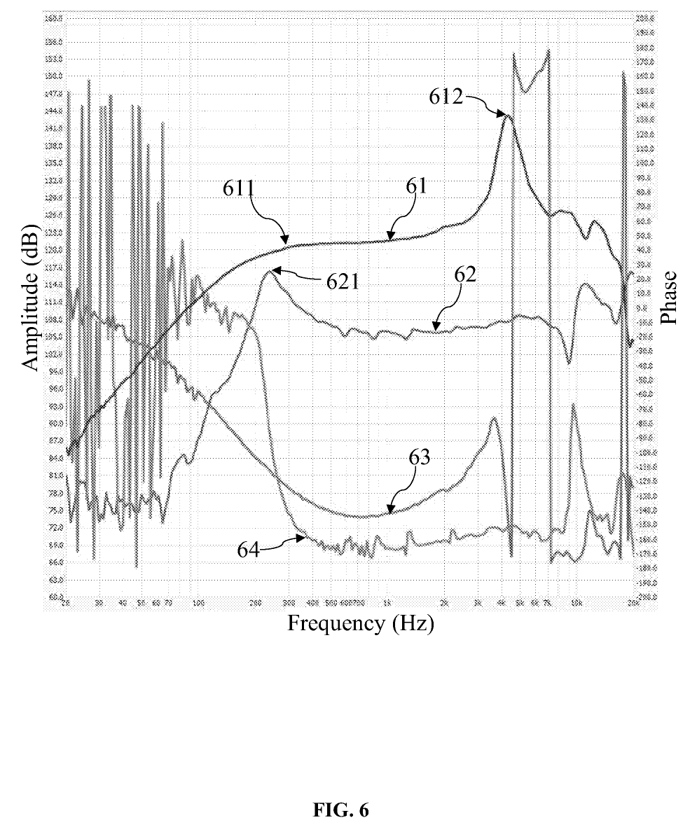

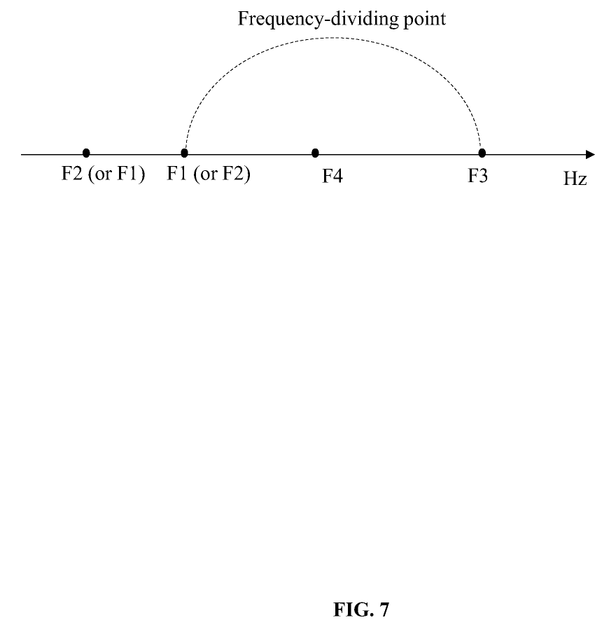

FIG. 6 is a schematic diagram of frequency response curves and phase curves of a bone conduction vibrator and an air conduction vibrator according to some embodiments of the present disclosure. FIG. 7 is a schematic diagram of a frequency-dividing point according to some embodiments of the present disclosure.

Referring to FIG. 6, a curve 61 is a frequency response curve of the air conduction vibrator, and a curve 63 is a phase curve of an air-conducted sound wave. A curve 62 is a frequency response curve of the bone conduction vibrator, and a curve 64 is a phase curve of a bone-conducted sound wave. As shown in FIG. 6, the bone conduction vibrator has a first resonance peak 621 at a first resonant frequency (e.g., 250 Hz). The first one of high-frequency modes of the bone conduction vibrator appears after 7000 Hz. Merely by way of example, the first one of high-frequency modes of the bone conduction vibrator may be specifically manifested as a peak valley at approximately 9000 Hz in the frequency response curve of the bone conduction vibrator, followed by a resonance peak at approximately 11 kHz, as shown in FIG. 6. The air conduction vibrator has a second resonance peak 611 at a second resonant frequency (e.g., 300 Hz) (the resonance peak may be considered as the first one of resonance peaks generated by the air conduction vibrator), and has a third resonance peak 612 at a third resonant frequency (e.g., 4200 Hz) (i.e., the first one of high-frequency resonance peaks of the air conduction vibrator). In some embodiments, the first resonance peak 621 may be the first one of resonance peaks generated by the bone conduction vibrator in a frequency domain, i.e., a resonance peak having a minimum resonant frequency. The second resonance peak 611 may be the first one of resonance peaks generated by the air conduction vibrator in the frequency domain, i.e., a resonance peak having the minimum resonant frequency.

According to the frequency response curve 62 and the phase curve 64 of the bone conduction vibrator, it can be seen that the phase of the bone conduction signal is relatively stable in a frequency band between the first resonance peak 621 and the occurrence of the first one of high-frequency modes of the bone conduction vibrator. According to the frequency response curve 61 and the phase curve 63 of the air conduction vibrator, it can be seen that the phase of the air-conducted sound wave is relatively stable in a frequency band between the second resonance peak 611 and the third resonance peak 612 (the first one of high-frequency resonance peaks of the air conduction vibrator).

In some embodiments, to make the bone-conducted sound wave and the air-conducted sound wave generated by the acoustic output device in an overlapping frequency band of the bone-conducted sound wave and the air-conducted sound wave to mutually superimpose and enhance at the cochlea of the user, the bone-conducted sound wave and the air-conducted sound wave need to have a same or substantially same phase in the overlapping frequency band. In this case, the frequency-dividing point of the first audio signal and the second audio signal may be located in a frequency band where phases of the bone conduction vibrator and the air conduction vibrator are relatively stable. This facilitates processing through hardware, software, or a combination thereof to enable the obtained first audio signal and second audio signal to stably maintain the same or substantially same phase in the frequency band where the phase is relatively stable, thereby causing the bone-conducted sound wave and the air- conducted sound wave to be in phase and enhance at the cochlea of the user, and further improving the sound listening effect of the user.

In some embodiments, to ensure that an acoustic output effect of the acoustic output device in a relatively low frequency band (e.g., 300 Hz-1000 Hz) is good, it is required that when the frequency-dividing point is in the lower frequency band, phases of the bone-conducted sound wave and the air-conducted sound wave are relatively stable. Since a phase of the bone-conducted sound wave and/or the air-conducted sound wave fluctuates greatly before frequencies corresponding to their respective first one of resonance peaks (i.e., the first resonant frequency and/or the second resonant frequency), the frequency-dividing point may be greater than the first resonant frequency and the second resonant frequency, i.e., the frequency-dividing point may be greater than a larger one of the first resonant frequency and the second resonant frequency. In some embodiments, to ensure that the acoustic output effect of the acoustic output device in a relatively high frequency band (e.g., 2500 Hz-5000 Hz) is good, it is required that when the frequency-dividing point is in the higher frequency band, phases of the bone-conducted sound wave and the air-conducted sound wave are relatively stable. Since the first one of high-frequency resonant frequencies of the bone conduction vibrator is greater than the first one of high-frequency resonant frequencies of the air conduction vibrator, and after a frequency (i.e., the third resonant frequency) corresponding to the first one of high-frequency resonance peaks of the air conduction vibrator, the phase of the air-conducted sound wave fluctuates greatly, the frequency-dividing point may be less than the first one of high-frequency resonant frequencies of the bone conduction vibrator and the first one of high-frequency resonant frequencies (i.e., the third resonant frequency) of the air conduction vibrator, i.e., the frequency-dividing point may be less than the smaller one of the first one of high-frequency resonant frequencies of the bone conduction vibrator and the first one of high-frequency resonant frequencies (i.e., the third resonant frequency) of the air conduction vibrator.

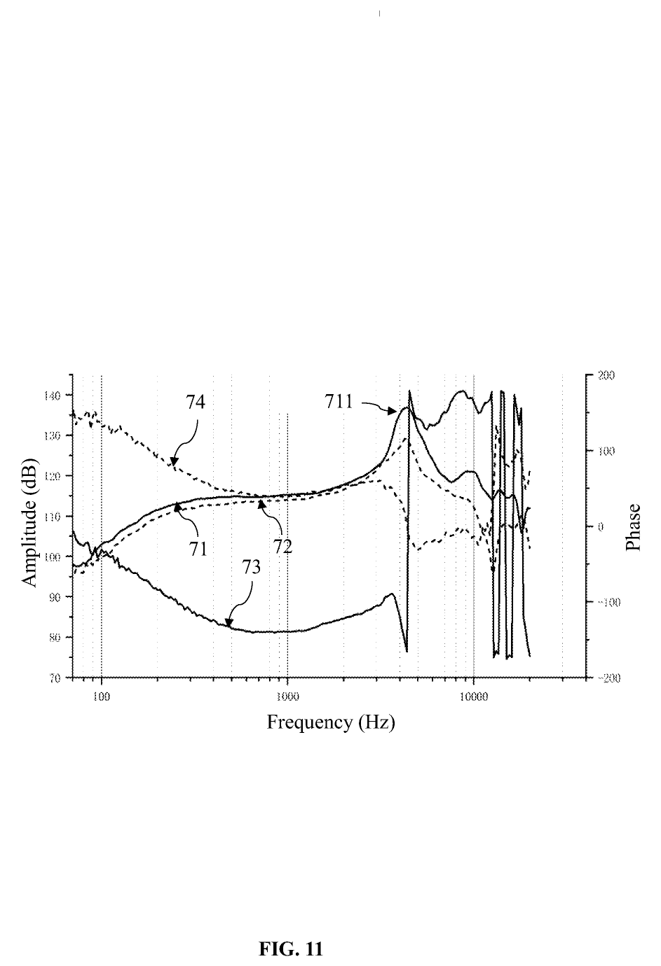

In some embodiments, to ensure that an acoustic output effect of the acoustic output device in a frequency band (e.g., 300 Hz-3500 Hz) to which a human ear is sensitive is good, it is required that when the frequency-dividing point is in the frequency band to which the human ear is sensitive, phases of the bone-conducted sound wave and the air-conducted sound wave are relatively stable. Since the phase of the bone-conducted sound wave is stable between the first resonant frequency and the first one of high-frequency resonant frequencies of the bone-conducted sound wave, the phase of the air-conducted sound wave is stable between the second resonant frequency and the third resonant frequency, and the first one of high-frequency resonant frequencies of the bone conduction vibrator is greater than the third resonant frequency of the air conduction vibrator, the frequency-dividing point is located in a frequency range between the second resonant frequency or the first resonant frequency and the third resonant frequency. For ease of understanding, further description is provided with reference to FIG. 7. In this case, when the first resonant frequency F1 is higher than the second resonant frequency F2 (or the second resonant frequency F2 is higher than the first resonant frequency F1), since the first one of high-frequency resonant frequencies of the bone conduction vibrator is higher than the first one of high-frequency resonant frequencies (i.e., the third resonant frequency F3) of the air conduction vibrator, the frequency-dividing point F4 is greater than the first resonant frequency F1 (or the second resonant frequency F2), and the frequency-dividing point F4 is less than the first one of high-frequency resonant frequencies (i.e., the third resonant frequency F3) of the air conduction vibrator. Therefore, to ensure that the acoustic output effect of the acoustic output device in a frequency band (e.g., 300 Hz-3500 Hz) to which a human ear is sensitive is good, the frequency-dividing point F4 is located in a frequency range between the first resonant frequency F1 (or the second resonant frequency F2) and the third resonant frequency F3. More descriptions of the third resonant frequency may refer to FIG. 11 and its description.

In some embodiments of the present disclosure, by setting the frequency-dividing point to be located in a range where phases are relatively stable in phase curves of the bone conduction vibrator and the air conduction vibrator to ensure that phases of the bone-conducted sound wave and the air-conducted sound wave near the frequency-dividing point tend to be stable, it can be easier to ensure that the phases of the bone-conducted sound wave and the air-conducted sound wave are the same, and ensure that a sound signal near the frequency-dividing point does not exhibit a sudden sharp drop (e.g., the frequency response curve exhibits a "concave" shape near the frequency-dividing point) relative to frequency bands before and after the frequency-dividing point, thereby achieving "superposition" of the bone-conducted sound wave and the air-conducted sound wave near the frequency-dividing point and producing an effect of in-phase enhancement.

In some embodiments, since the acoustic output device uses the air conduction vibrator to provide mid-low frequency output and uses the bone conduction vibrator to provide mid-high frequency output, continuing to refer to FIG. 6 and FIG. 7, to ensure an output effect of the acoustic output device at low frequencies, the second resonant frequency F2 is preferably lower. Meanwhile, to improve the bone-conducted sound of the bone conduction vibrator in a mid-high frequency range, the first resonant frequency F1 should not be too small. In this case, the second resonant frequency F2 may be set to be less than the first resonant frequency F1, so that the air-conducted sound output by the air conduction vibrator in a low frequency range has a larger sound pressure amplitude value, while the bone-conducted sound output by the bone conduction vibrator in a mid-high frequency range has a larger sound pressure amplitude value. For example, the first resonant frequency F1 is in a range of 300 Hz-500 Hz, and the second resonant frequency F2 is in a range of 100 Hz-300 Hz. As another example, the first resonant frequency F1 is in a range of 300 Hz-400 Hz, and the second resonant frequency F2 is in a range of 150 Hz-250 Hz.

In some embodiments of the present disclosure, by setting the second resonant frequency to be less than the first resonant frequency, it is ensured that the air conduction vibrator can also have a relatively large output in a relatively low frequency range, thereby ensuring that the low-frequency output of the air conduction vibrator can cover a wider low-frequency range, so that the acoustic output device can ensure a higher acoustic output in a relatively wide frequency range, thereby ensuring a good acoustic effect of the acoustic output device in an audible threshold (e.g., 20 Hz-5000 Hz).

In some embodiments, in some scenarios requiring vibration output, such as simulating gunshots in games, vibrations of a car, vibration feedback of a prompt tone, etc., to make the acoustic output device 100 output sound while being more suitable for the scenario application, so as to provide a better experience for the user, the second resonant frequency F2 may be set to be greater than the first resonant frequency F1. In some embodiments, by setting the second resonant frequency F2 to be greater than the first resonant frequency F1, the mid-frequency sensitivity of the air conduction vibrator can be improved, the power consumption of the entire device at high volume can be reduced, and the battery life of the acoustic output device 100 can be increased. In addition, the reliability against mechanical impacts such as drops can also be improved.

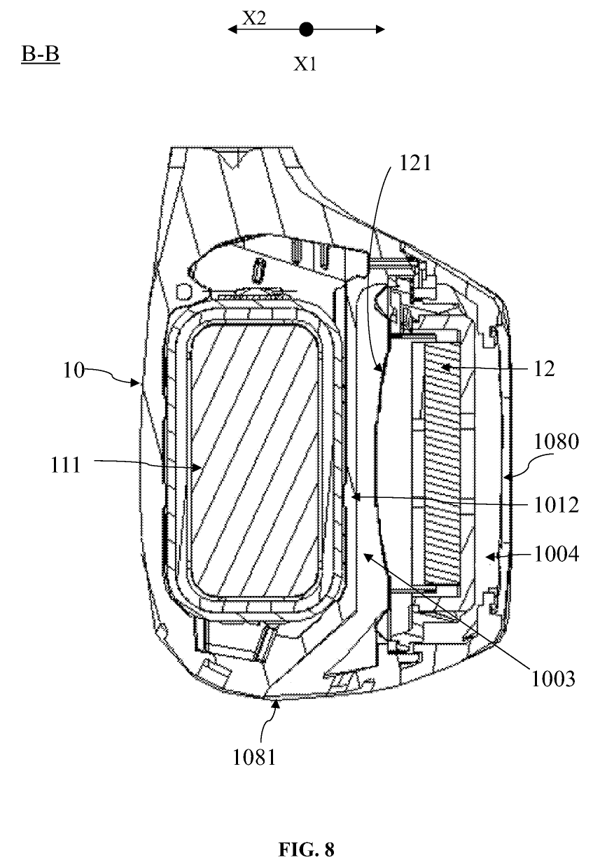

FIG. 8 is a schematic diagram of a cross-section of a core assembly along a B- B direction according to some embodiments of the present disclosure.

In some embodiments, with reference to FIG. 3 and FIG. 8, the bone conduction vibrator 11 includes a vibration plate 111. The vibration plate 111 generates mechanical vibration along a first vibration direction X1 (i.e., a direction perpendicular to the paper surface) under the driving of the first audio signal. Vibration of the vibration plate 111 is transmitted to the user as a bone-conducted sound wave via contact between the housing 10 and the skin of the user. The first resonant frequency F1 of the bone conduction vibrator 11 is related to a vibration system formed by the vibration plate 111, the housing 10, a magnetic circuit system (e.g., a magnetic conduction cover, a magnet, a coil, etc.) of the bone conduction vibrator 11, and a vibration transmission structure between the vibration plate 111 and the housing 10. A resonant frequency of the vibration system may be regarded as the first resonant frequency F1 of the bone conduction vibrator 11. It should be known that, in practical applications, since the air conduction vibrator 12 and the bone conduction vibrator 11 are integrated to form the acoustic output device 100, when the bone conduction vibrator 11 vibrates, the air conduction vibrator 12 may serve as a load of the bone conduction vibrator 11. Therefore, the air conduction vibrator 12 (e.g., its mass, vibration direction of a diaphragm, etc.) may affect the first resonant frequency F1 of the bone conduction vibrator 11. In this case, the first resonant frequency F1 of the bone conduction vibrator 11 may be related to the vibration system and the air conduction vibrator 12. A resonant frequency formed by the vibration system and the air conduction vibrator 12 may be regarded as the first resonant frequency F1 of the bone conduction vibrator 11.

In some embodiments, with reference to FIG. 3 and FIG. 8, the air conduction vibrator 12 includes a diaphragm 121. The diaphragm 121 divides the accommodation cavity 1002 into a rear cavity 1004 and a front cavity 1003 located on opposite sides of the diaphragm 121. The rear cavity 1004 is located on a side of the diaphragm 121 away from the partition wall 1012, and the front cavity 1003 is located between the diaphragm 121 and the partition wall 1012. The second audio signal drives the diaphragm 121 to generate mechanical vibration along a second vibration direction X2, and an air-conducted sound wave is generated through propagation via a medium such as air. The second resonant frequency F2 of the air conduction vibrator 12 is related to characteristics of the diaphragm 121. A resonant frequency of the diaphragm 121 may be regarded as the second resonant frequency F2 of the air conduction vibrator 12.

Generally, in a low-frequency range, vibration of the bone conduction vibrator 11 in a frequency range near the first resonant frequency F1 of the bone conduction vibrator 11 brings a strong vibration sensation to a face of the user. As the frequency of the bone-conducted sound wave output by the bone conduction vibrator 11 increases, the vibration sensation brought by the bone conduction vibrator 11 to the face of the user gradually weakens. For example, the bone conduction vibrator produces a strong vibration sensation (e.g., a face-hitting sensation) within 150 Hz-300 Hz, produces a weaker vibration sensation (e.g., a tingling sensation) within 300 Hz-400 Hz, and produces a relatively slight vibration sensation within 400 Hz-600 Hz. Therefore, in some embodiments, to avoid an output frequency of the bone conduction vibrator 11 being too low, which can cause the bone conduction vibrator 11 to produce too strong a vibration sensation and thereby bring a poor user experience, the frequency-dividing point may be not less than 300 Hz. In some embodiments, to further weaken the vibration sensation produced by the bone conduction vibrator 11, the frequency-dividing point may be not less than 350 Hz. In some embodiments, the frequency-dividing point may be not less than 400 Hz. In some embodiments, the frequency-dividing point may be not less than 500 Hz.

In some embodiments of the present disclosure, by setting the frequency-dividing point to be not less than 300 Hz, the bone conduction vibrator is prevented from producing more low-frequency vibrations, thereby avoiding an overly strong vibration sensation that leads to poor user experience, and ensuring low-frequency performance of the acoustic output device.

Starting from the first resonant frequency F1 or the second resonant frequency F2, the phase of the bone-conducted sound wave or the phase of the air-conducted sound wave tends to stabilize as the frequency increases. For example, as shown in FIG. 6, for the phase (corresponding to the curve 64) of the bone-conducted sound wave, in a frequency band range of 250 Hz-350 Hz, the phase of the bone-conducted sound wave gradually decreases. Starting from 350 Hz, the phase of the bone-conducted sound wave tends to stabilize. For the phase (corresponding to the curve 63) of the air-conducted sound wave, in a frequency band range of 200 Hz-300 Hz, the phase of the air-conducted sound wave gradually decreases. Starting from 300 Hz, the phase of the air-conducted sound wave tends to stabilize. It should be known that the phase of the bone-conducted sound wave or the air-conducted sound wave tending to stabilize may refer to a phase fluctuation of the bone-conducted sound wave or the air-conducted sound wave being less than a certain degree, e.g., 30 degrees, 20 degrees, 10 degrees, etc.

In some embodiments, to further ensure that the bone-conducted sound wave and the air-conducted sound wave are in phase and add constructively in the frequency band near the frequency-dividing point, the frequency-dividing point may be set away from the frequency band near the first resonant frequency F1 or the second resonant frequency F2 where the phase is still gradually increasing or gradually decreasing, so that it is located in a frequency band where the phases of both the bone-conducted sound wave and the air-conducted sound wave are stable. The frequency-dividing point may be located after the first resonant frequency F1 and the second resonant frequency F2, and at a certain distance from the first resonant frequency F1 and the second resonant frequency F2. For example, the difference between the first resonant frequency F1 and the frequency-dividing point, and the difference between the second resonant frequency F2 and the frequency-dividing point are each not less than 100 Hz. That is, the difference between the larger one of the first resonant frequency F1 and the second resonant frequency F2, and the frequency-dividing point is not less than 100 Hz. In some embodiments, to make the frequency-dividing point located in a frequency band where the phases of the bone-conducted sound wave and the air-conducted sound wave are more stable (e.g., the phase difference between the bone-conducted sound wave and the air-conducted sound wave is less than 20 degrees), the difference between the larger one of the first resonant frequency F1 and the second resonant frequency F2, and the frequency-dividing point may be not less than 200 Hz. In some embodiments, to make the frequency-dividing point located in a frequency band where the phases of the bone-conducted sound wave and the air-conducted sound wave are particularly stable (e.g., the phase difference between the bone-conducted sound wave and the air-conducted sound wave is less than 10 degrees), the difference between the larger one of the first resonant frequency F1 and the second resonant frequency F2 and the frequency-dividing point may be not less than 300 Hz.

In some embodiments of the present disclosure, by making the difference between the first resonant frequency and the frequency-dividing point and the difference between the second resonant frequency and the frequency-dividing point satisfy a certain threshold range, it is beneficial to ensure that the sound wave phase in the frequency band near the frequency-dividing point is in a stable interval. Furthermore, it can avoid differences in the phase of the bone-conducted sound wave and the air-conducted sound wave in the frequency band near the frequency-dividing point corresponding to different batches of devices due to fluctuations in the resonant frequencies of the bone conduction vibrator and/or the air conduction vibrator caused by differences in the preparation process among different batches of devices. This ensures the output performance of the acoustic output device and improves the output stability of the prepared acoustic output devices.

In some embodiments, because the air conduction vibrator drives a relatively small air load, power consumption can be effectively reduced. To make more of the acoustic output of the acoustic output device be output in the form of the air-conducted sound wave, thereby reducing the power consumption of the acoustic output device, the frequency-dividing point may be set in a relatively high frequency band, e.g., 1000 Hz-2000 Hz, 1500 Hz-2500 Hz, etc. However, in this case, the human ear is relatively sensitive to the air-conducted sound near the frequency-dividing point and having a frequency lower than the frequency-dividing point, causing the sound leakage of the acoustic output device to be easily perceived by surrounding people, which may affect the listening experience and listening privacy of the user.

Therefore, in some embodiments, continuing to refer to FIG. 8, to reduce the sound leakage of the acoustic output device, a first sound guiding hole 1080 and a second sound guiding hole 1081 may be provided on the housing 10 (e.g., the first housing 101, the second housing 102, and/or the third housing 103) of the acoustic output device 100. The first sound guiding hole 1080 communicates the rear cavity 1004 with the external environment. The second sound guiding hole 1081 communicates the front cavity 1003 with the external environment. The first sound guiding hole 1080 is configured to conduct and output the air-conducted sound wave generated by the air conduction vibrator 12. The second sound guiding hole 1081 is configured to perform pressure relief for the air conduction vibrator 12, ensuring the normal and stable operation of the air conduction vibrator 12. In some embodiments, the air conduction vibrator 12 may radiate sound with equal amplitude and opposite phase to the outside via the two sound guiding holes (i.e., the first sound guiding hole 1080 and the second sound guiding hole 1081). In this case, the first sound guiding hole 1080 and the second sound guiding hole 1081 may form a dipole output structure to reduce the sound leakage of the air conduction vibrator 12 in the far field, thereby improving the listening experience and listening privacy of the user.

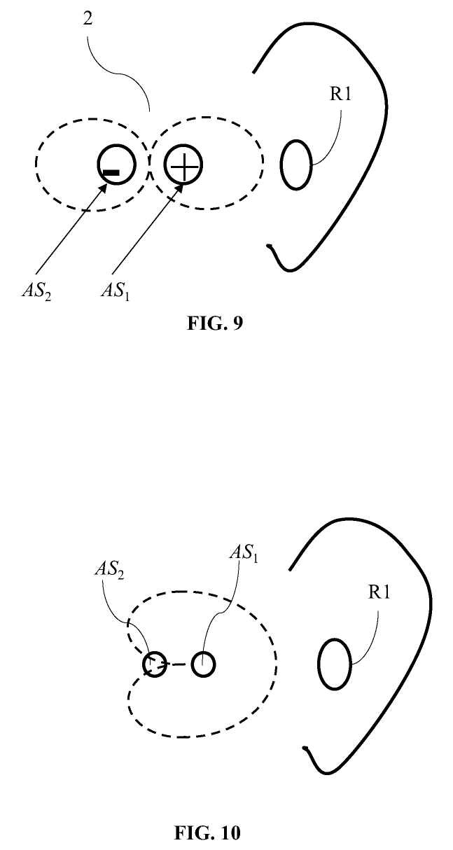

FIG. 9 is a schematic diagram of an exemplary sound field of a dipole according to some embodiments of the present disclosure. Referring to FIG. 9, the air-conducted sound wave output by the acoustic output device is exported along the first sound guiding hole 1080 and the second sound guiding hole 1081. The first sound guiding hole and the second sound guiding hole may be regarded as a first sound source AS₁ and a second sound source AS₂ with equal (or substantially equal) amplitude and opposite (or substantially opposite) phase. The first sound source AS₁ and the second sound source AS₂ form a dipole 2 or a dipole-like structure. The dipole 2 or the dipole-like structure may form a radiation sound field similar to the "8" shape as shown in FIG. 9. In the direction of the straight line where the first sound guiding hole 1080 and the second sound guiding hole 1081 are connected, the sounds radiated by the sound guiding holes are the greatest, and the sound radiated in other directions is significantly smaller. Therefore, by providing at least two sound guiding holes in the acoustic output device to construct the dipole or the dipole-like structure, the sound radiated by the acoustic output device to the surrounding environment (i.e., far-field sound leakage) can be reduced.

Therefore, in some embodiments, to enable the first sound guiding hole 1080 and the second sound guiding hole 1081 to form the dipole or the dipole-like structure, thereby improving the sound leakage reduction capability of the acoustic output device, an amplitude difference between the sounds radiated through the two sound guiding holes may be made less than 6 dB (e.g., the amplitude difference is 1 dB, 3 dB, 5 dB, etc.), and the phase difference between the sounds radiated through the two sound guiding holes may be in the range of 150°-210°. In some embodiments, to make the dipole-like structure formed by the first sound guiding hole 1080 and the second sound guiding hole 1081 more standard, thereby further improving the sound leakage reduction capability of the acoustic output device, the amplitude difference between the sounds radiated through the two sound guiding holes is less than 5 dB, and the phase difference between the sounds radiated through the two sound guiding holes is in the range of 160°-200°. In some embodiments, the amplitude difference between the sounds radiated through the two sound guiding holes is less than 3 dB, and the phase difference between the sounds radiated through the two sound guiding holes is in the range of 170°-190°. In some embodiments, the amplitude difference between the sounds radiated through the two sound guiding holes is less than 3 dB, and the phase difference between the sounds radiated through the two sound guiding holes is in the range of 175°-185°. In some embodiments, to make the amplitude difference between the sounds radiated through the two sound guiding holes less than 6 dB, the near-field sound pressure level difference between the two sound guiding holes may be made less than 6 dB. It should be understood that the smaller the near-field sound pressure level difference, the more significant the cancellation by sound waves with the same amplitude and opposite phase in the far field, and the better the effect of reducing the sound leakage.

In the present disclosure, the near-field sound pressure level difference refers to the difference in the sound pressure levels of the sounds radiated through the two sound guiding holes to their respective near-field positions. The near-field position of a sound guiding hole may refer to a position within 5 mm from the sound guiding hole. For ease of understanding, the near-field sound pressure level difference may be represented as the difference in the sound pressure levels at the two sound guiding holes of the acoustic output device 100.

In some embodiments, the test manner for the near-field sound pressure level may be, at a specific frequency point (e.g., 1000 Hz), to measure the sound pressures of the sounds (respectively a first sound and a second sound) radiated through the first sound guiding hole and the second sound guiding hole respectively, and then calculate (e.g., take the common logarithm of the ratio of the sound pressure to be measured to a reference sound pressure, and then multiply by 20 to obtain the sound pressure level) to obtain the sound pressure level difference between the first sound and the second sound. In some embodiments, when testing the sound of the first sound guiding hole (or the second sound guiding hole), a baffle may be used to separate the first sound guiding hole and the second sound guiding hole to avoid interference from the second sound guiding hole (or the first sound guiding hole) to the test. The sound pressure at the first sound guiding hole may be understood as the sound pressure at a position close to the first sound guiding hole. The sound pressure at the second sound guiding hole may be understood as the sound pressure at a position close to the second sound guiding hole. For example, a sound collection device may be placed at a distance of 4 mm from the first sound guiding hole (or the second sound guiding hole) to collect the first sound (or the second sound) as the sound pressure at the first sound guiding hole (or the second sound guiding hole).

In some embodiments, when testing the sounds of the first sound guiding hole and the second sound guiding hole, the positions at a distance of 4 cm from the first sound guiding hole and the second sound guiding hole (i.e., the collection positions) may be in a pair of opposite directions of the acoustic output device 100 respectively (e.g., the position 4 cm from the first sound guiding hole is in the direction from the second sound guiding hole pointing to the first sound guiding hole, and the position 4 cm from the second sound guiding hole is in the direction from the first sound guiding hole pointing to the second sound guiding hole). The sound collection device is placed at the two collection positions respectively to collect the sound pressure levels of the acoustic output device 100, and the difference between the two sound pressure levels is calculated, which is the near-field sound pressure level difference between the first sound guiding hole and the second sound guiding hole.

By controlling the near-field sound pressures of the sounds radiated through the first sound guiding hole and the second sound guiding hole to be similar, it can be ensured that the first sound and the second sound effectively interfere and cancel each other out in specific directions in the far field, thereby effectively reducing the far-field sound leakage of the acoustic output device 100.

In some embodiments of the present disclosure, by making the air conduction vibrator output mid-low frequency sounds and the bone conduction vibrator output mid-high frequency sounds, it is beneficial to reduce the vibration sensation caused by the acoustic output device. Furthermore, by setting a higher frequency-dividing point, more of the acoustic output of the acoustic output device is output in the form of the air-conducted sound wave, which is beneficial for reducing the power consumption of the acoustic output device. At the same time, by making the amplitude difference and the phase difference between the sounds radiated through the two sound guiding holes satisfy certain conditions, the two sound guiding holes may constitute a dipole or a dipole-like structure, thereby improving the ability of the acoustic output device to reduce sound leakage in the mid-low frequencies.

In some embodiments, the near-field sound pressure level difference can be adjusted by adjusting a difference between acoustic loads of the two sound guiding holes. The acoustic load refers to a ratio of the sound pressure value P1 after passing through the sound guiding hole to the sound pressure value P0 without passing through the sound guiding hole, i.e., the acoustic load equals P1/P0. It should be noted that, for the acoustic load of a certain sound guiding hole, the larger the acoustic load (or, the closer it is to 1), the smaller its acoustic resistance.

In some embodiments, the acoustic load may be determined by measuring the sound pressure value when the sound guiding hole is covered with a mesh screen (equivalent to P1) and the sound pressure value when it is not covered with a mesh screen (equivalent to P0) at a specific distance, respectively, and calculating the ratio of P1 to P0. Specifically, when testing the sound of a sound guiding hole, a sound collection device may be placed at a distance of 4-5 mm from the sound guiding hole, and then the sound pressure value when the sound guiding hole is covered with a mesh screen (equivalent to P1) and the sound pressure value when it is not covered with a mesh screen (equivalent to P0) are collected respectively, and finally the acoustic load of the sound guiding hole is calculated. It should be noted that a test signal for the acoustic load may be a single-frequency signal, and one or more frequency points may be selected in the test signal. For example, the one or more frequency points may include, but are not limited to, 100 Hz, 200 Hz, 300 Hz, 500 Hz, 1000 Hz, 2000 Hz, 5000 Hz, and the resonant frequency of the acoustic output device, etc. The test signal may also be white noise, pink noise, or a frequency sweep signal. It should be noted that, in some embodiments, the measured sound pressure level needs to be converted to a sound pressure value first, and then the acoustic load is calculated. Alternatively, the difference between the sound pressure levels measured before and after covering the sound guiding hole with the mesh screen may be taken, and then the acoustic load value of the sound guiding hole may be inversely calculated using the logarithmic formula.

In some embodiments, the difference between the acoustic loads of the two sound guiding holes may include 0.1, 0.15, 0.2, etc. In some embodiments, the difference between the acoustic loads of the two sound guiding holes may be less than 0.15. It should be understood that the smaller the difference between the acoustic loads of the two sound guiding holes, the closer the acoustic resistances of the two sound guiding holes are, and thus the smaller the near-field sound pressure level difference between the two sound guiding holes, and consequently the more significant the effect of reducing far-field sound leakage.

In some embodiments, the difference between the acoustic loads of the two sound guiding holes may be less than 0.1. By further narrowing the range of the difference between the acoustic loads of the two sound guiding holes, the near-field sound pressure level difference between the two sound guiding holes may be further reduced, thereby further improving the effect of reducing far-field sound leakage. To reduce the power consumption of the acoustic output device 100, the frequency-dividing point may be shifted toward a high frequency. When the frequency-dividing point is shifted toward the high frequency, i.e., the air-conducted sound wave output by the acoustic output device 100 includes more high-frequency components, the far-field sound leakage of the acoustic output device 100 gradually increases. Therefore, when the frequency-dividing point is shifted toward the high frequency, the difference between the acoustic loads of the two sound guiding holes may be reduced, thereby further improving the effect of reducing the far-field sound leakage to ensure an output performance of the acoustic output device 100.

In some embodiments, to reduce the power consumption of the acoustic output device 100, the frequency-dividing point may be set in a range of 300 Hz-1 kHz. In this case, to keep the far-field sound leakage of the acoustic output device 100 relatively small, the difference between the acoustic loads of the two sound guiding holes may be in a range of 0-0.12. In some embodiments, to further reduce the power consumption of the acoustic output device 100, the frequency-dividing point may be set in a range of 1 kHz-2 kHz. In this case, to keep the far-field sound leakage of the acoustic output device 100 (or the air conduction vibrator 12) relatively small, the difference between the acoustic loads of the two sound guiding holes may be in a range of 0-0.1. In some embodiments, to further reduce the power consumption of the acoustic output device 100, the frequency-dividing point may be set in a range of 1.5 kHz-2.5 kHz. In this case, to keep the far-field sound leakage of the acoustic output device 100 (or the air conduction vibrator 12) relatively small, the difference between the acoustic loads of the two sound guiding holes may be in a range of 0-0.07. In some embodiments, to reduce the power consumption of the acoustic output device 100, the frequency-dividing point may be set in a range of 2 kHz-3 kHz. In this case, to keep the far-field sound leakage of the acoustic output device 100 (or the air conduction vibrator 12) relatively small, the difference between the acoustic loads of the two sound guiding holes may be in a range of 0-0.05.

In some embodiments, the near-field sound pressure level difference may also be adjusted by adjusting a ratio of surface acoustic loads of the two sound guiding holes.

The surface acoustic load refers to a product of a ratio of a sound pressure value P1 after passing through the sound guiding hole to a sound pressure value P0 before passing through the sound guiding hole and an area S of the sound guiding hole, i.e., the surface acoustic load equals S×P1/P0.

In some embodiments, the ratio of the surface acoustic loads of the two sound guiding holes may be 0.5, 1, 2.5, etc. In some embodiments, a ratio range of the surface acoustic loads of the two sound guiding holes may be 0.5-3.5. By adjusting the ratio of the surface acoustic loads of the two sound guiding holes to keep it within a suitable range, the acoustic resistances of the two sound guiding holes may become closer, thereby reducing the near-field sound pressure level difference between the two sound guiding holes, so as to improve the effect of reducing the far-field sound leakage.

Further, the ratio range of the surface acoustic loads of the two sound guiding holes may be 0.8-2. It may be understood that by further narrowing the ratio range of the surface acoustic loads of the two sound guiding holes, the effect of reducing the far-field sound leakage may become more significant. To reduce the power consumption of the acoustic output device 100, the frequency-dividing point may be shifted toward the high frequency. When the frequency-dividing point is shifted toward the high frequency, i.e., the air-conducted sound wave output by the acoustic output device 100 includes more high-frequency components, the far-field sound leakage of the acoustic output device 100 gradually increases. Therefore, when the frequency-dividing point is shifted toward the high frequency, the ratio of the surface acoustic loads of the two sound guiding holes may be reduced, thereby further improving the effect of reducing the far-field sound leakage to ensure the output performance of the acoustic output device 100.

In some embodiments, to reduce the power consumption of the acoustic output device 100, the frequency-dividing point may be set in a range of 300 Hz-1 kHz. In this case, to keep the far-field sound leakage of the acoustic output device 100 relatively small, the ratio range of the surface acoustic loads of the two sound guiding holes may be 0.5-3.5. In some embodiments, to further reduce the power consumption of the acoustic output device 100, the frequency-dividing point may be set in a range of 1 kHz-2 kHz. In this case, to keep the far-field sound leakage of the acoustic output device 100 (or the air conduction vibrator 12) relatively small, the ratio range of the surface acoustic loads of the two sound guiding holes may be 0.6-2.7. In some embodiments, to further reduce the power consumption of the acoustic output device 100, the frequency-dividing point may be set in a range of 1.5 kHz-2.5 kHz. In this case, to keep the far-field sound leakage of the acoustic output device 100 (or the air conduction vibrator 12) relatively small, the ratio range of the surface acoustic loads of the two sound guiding holes may be 0.7-2. In some embodiments, to reduce the power consumption of the acoustic output device 100, the frequency-dividing point may be set in a range of 2 kHz-3 kHz. In this case, to keep the far-field sound leakage of the acoustic output device 100 (or the air conduction vibrator 12) relatively small, the ratio range of the surface acoustic loads of the two sound guiding holes may be 0.9-1.2.

In some embodiments of the present disclosure, by adjusting the difference between the acoustic loads and/or the ratio of the surface acoustic loads of the two sound guiding holes, the acoustic resistances of the two sound guiding holes become closer, thereby reducing the near-field sound pressure level difference between the two sound guiding holes, enabling construction of the dipole or dipole-like structure, and thus improving the effect of reducing the far-field sound leakage.

In some embodiments, in a relatively high frequency band (e.g., 500 Hz-3000 Hz), when an acoustic output of the acoustic output device is output in the form of an air-conducted sound wave, the sound leakage generated by the air-conducted sound wave may affect the listening experience and listening privacy of the user. Therefore, in some embodiments, to further reduce the sound leakage of the acoustic output device, the first sound guiding hole 1080 and the second sound guiding hole 1081 may be caused to radiate sound having a phase difference and/or an amplitude difference to the outside, so as to adjust a sound field radiated by the dipole or dipole-like structure. Specifically, by controlling the amplitude difference and the phase difference of the two sounds output by the acoustic output device, the degree of cancellation of the sound output by the acoustic output device in the far field may be changed. Moreover, when the phase difference satisfies a certain condition, the acoustic output device may output a large volume in a certain direction (e.g., a direction where an ear canal opening R1 of the user is located) while suppressing sound leakage output by the acoustic output device in an opposite direction. At this time, a sound field radiated by the first sound guiding hole 1080 and the second sound guiding hole 1081 is shown in FIG. 10.

FIG. 10 is a schematic diagram of an exemplary radiation directivity sound field of the acoustic output device according to some embodiments of the present disclosure. Referring to FIG. 10, a first sound source AS₁ generates a first sound, and a second sound source AS₂ generates a second sound. When the first sound and the second sound have a specific amplitude difference and/or phase difference, the first sound source AS₁ and the second sound source AS₂ may form a highly directional radiation sound field. At this time, the directivity may be manifested in that the sounds radiated from the two sound guiding holes have a far-field sound pressure level difference of not less than 3 dB in at least one pair of opposite directions (e.g., a direction where the ear canal is located and its opposite direction). Thus, a volume in the direction where the ear canal of the user is located may be relatively large, while sound leakage in the opposite direction of the direction where the ear canal of the user is located and in other directions may be relatively small, thereby better balancing ear canal openness and listening privacy. Merely by way of example, as shown in FIG. 10, the highly directional radiation sound field has only one main lobe. Sound field radiation near the main lobe is strong, while sound field radiation in other directions is weak (a sound field intensity in the opposite direction of the main lobe is also relatively weak). When the user wears the acoustic output device, the main lobe may be directed toward the ear canal opening R1 of the user. At this time, only radiation directed toward the ear canal opening R1 and its vicinity is strong, while other directions are weak directivity directions. Thereby, sound leakage reduction of the acoustic output device 100 may be further achieved.

The far-field sound pressure level difference refers to a difference in sound pressure amplitude values of sounds respectively radiated through the two sound guiding holes in the far field. The far field of the sound guiding hole may refer to a position 10 cm or more away from the sound guiding hole. For ease of understanding, the far-field sound pressure level difference of the two sound guiding holes may be expressed as a difference in sound pressure amplitude values at relatively far distances (or symmetrical positions) that are the same or approximately the same from the two holes along a line connecting the two sound guiding holes. When measuring the sound pressure amplitude value of the sound guiding hole, for example, when collecting sound from the first sound guiding hole (or the second sound guiding hole), a sound collection device may be placed 30 cm away from the first sound guiding hole (or the second sound guiding hole) for collection.

In some embodiments, the far-field sound pressure level difference of the two sound guiding holes may be controlled by setting the amplitude difference and the phase difference of the sounds radiated through the two sound guiding holes. It should be noted that the phase of the sound radiated through the sound guiding hole (e.g., the first sound guiding hole 1080 and the second sound guiding hole 1081) described in the embodiments of the present disclosure may refer to a phase measured at a position 4 mm away from the sound guiding hole (or a geometric center of the sound guiding hole) (e.g., 4 mm in front of the sound guiding hole). In some embodiments, a manner for testing the phase difference may include respectively measuring the phases of the sounds radiated through the two sound guiding holes (which are the first sound and the second sound, respectively), and then calculating the phase difference between the first sound and the second sound. When testing the sound of the first sound guiding hole (or the second sound guiding hole), a baffle may be used to separate the first sound guiding hole and the second sound guiding hole to avoid interference from the first sound guiding hole (or the second sound guiding hole) with the test. Further, the sound collection device may be placed on a line connecting the first sound guiding hole and the second sound guiding hole and 4 mm away from the first sound guiding hole (or the second sound guiding hole) to collect the first sound, further avoiding interference from the first sound guiding hole (or the second sound guiding hole) with the test. Merely by way of example, the baffle may have a standard size. For example, the length, width, and height dimensions of the baffle may be 1650 mm, 1350 mm, and 30 mm, respectively. It should be further noted that when a count of the first sound guiding holes (or the second sound guiding holes) is two or more, any one of them may be selected for testing. For example, one first sound guiding hole and one second sound guiding hole located at specific relative positions (e.g., with a minimum or maximum relative distance) may be selected, the phases of the sounds respectively radiated through them may be tested, and the phase difference may be calculated. In addition, sound measurement in a specific frequency band (e.g., 0 Hz-8000 Hz) need not be achieved by exhaustion. Instead, a plurality of (e.g., 20-30) frequency sampling points with equal step sizes and endpoints being endpoints of the frequency band may be set, and the sound at each sampling point may be measured.

In some embodiments, the front cavity 1003 or the rear cavity 1004 of the air conduction vibrator 12 may form a third resonance peak having a third resonant frequency. Specifically, referring to FIG. 8, the first sound guiding hole 1080 and the rear cavity 1004 may be approximately regarded as a Helmholtz resonator model. The rear cavity 1004 is a cavity of the Helmholtz resonator model, and the first sound guiding hole 1080 is a neck of the Helmholtz resonator model. At this point, a resonant frequency of the Helmholtz resonator model is the resonant frequency of the rear cavity 1004. Similarly, the second sound guiding hole 1081 and the front cavity 1003 may be approximately regarded as a Helmholtz resonator model. The front cavity 1003 is a cavity of the Helmholtz resonator model, and the second sound guiding hole 1081 is a neck of the Helmholtz resonator model. At this point, a resonant frequency of the Helmholtz resonator model is the resonant frequency of the front cavity 1003. For convenience of description, a smaller one of the resonant frequencies of the front cavity 1003 and the rear cavity 1004 is defined as the third resonant frequency.

In the present disclosure, the third resonance peak is measured by measuring the first one of high-frequency resonance peaks of a frequency response curve of the air conduction vibrator 12 when an input signal of the bone conduction vibrator 11 is disconnected, and a resonant frequency corresponding to the third resonance peak is the third resonant frequency. Specifically, the third resonance peak of the sound generated by the front cavity 1003 or the rear cavity 1004 is measured when the first sound guiding hole 1080 and the second sound guiding hole 1081 are separated by a baffle.

FIG. 11 is a schematic diagram of frequency response curves and phase curves of sound signals output from two sound guiding holes coupled to a front cavity and a rear cavity of an air conduction vibrator according to some embodiments of the present disclosure.

Referring to FIG. 11, a curve 71 is a frequency response curve of the first sound guiding hole, a curve 73 is a phase curve corresponding to the first sound guiding hole, a curve 72 is a frequency response curve of the second sound guiding hole, and a curve 74 is a phase curve corresponding to the second sound guiding hole. As shown in FIG. 11, amplitude values of the frequency response curves of the two sound guiding holes are substantially the same (corresponding to the curves 71 and 72), and an amplitude deviation of the frequency response curves of the two sound guiding holes is about ±6 dB. A phase difference between the two sound guiding holes is 180° (or close to 180°). After the third resonance peak 711 corresponding to the third resonant frequency, vibration modes on the frequency response curve 71 or 72 increase. Correspondingly, phase jumps become frequent, and the two sound guiding holes cannot stably maintain a phase difference of 180° (or close to 180°), resulting in a poor dipole effect formed by the air conduction vibrator through the two sound guiding holes, and an inability to effectively reduce sound leakage. In addition, if the frequency-dividing point is located near the third resonant frequency, due to frequent phase jumps of the air-conducted sound wave, it is difficult for the sound waves output by the air conduction vibrator and the bone conduction vibrator to remain in phase with each other. Therefore, in some embodiments, whether from the perspective of reducing sound leakage of the air conduction or maintaining phase stability of the bone-conducted sound wave and the air-conducted sound wave near the frequency-dividing point, the frequency-dividing point should avoid a frequency band where the air conduction vibrator has complex vibration modes, i.e., the frequency-dividing point is less than the third resonant frequency.

In some embodiments of the present disclosure, by setting the frequency-dividing point to be less than the third resonant frequency, the frequency-dividing point may avoid the frequency band where the air conduction vibrator has complex vibration modes, thereby preventing the dipole effect formed by the air conduction vibrator through the two sound guiding holes from deteriorating and failing to effectively reduce sound leakage, and simultaneously avoiding insufficient phase stability of the sound waves output by the air conduction vibrator and the bone conduction vibrator, which makes it difficult to keep them in phase.

In some embodiments, to enable the two sound guiding holes to stably maintain a phase difference of 180° (or close to 180°) to ensure the effect of reducing the sound leakage of the air conduction vibrator, the frequency-dividing point may not be higher than 3000 Hz. In some embodiments, to ensure the effect of reducing the sound leakage of the air conduction vibrator, the frequency-dividing point may not be higher than 2500 Hz. In some embodiments, to ensure the effect of reducing the sound leakage of the air conduction vibrator, the frequency-dividing point may not be higher than 2000 Hz.

In some embodiments, with reference to FIG. 6 and FIG. 7, in a frequency band before the third resonant frequency F3, a phase of the air-conducted sound wave gradually increases as frequency increases, i.e., the phase of the air-conducted sound wave before the third resonant frequency F3 transitions from stable to fluctuating. Therefore, to more easily ensure that the bone-conducted sound wave and the air-conducted sound wave are in phase and reinforce each other in a frequency band near the frequency-dividing point, the frequency-dividing point F4 may be kept away from the third resonant frequency F3, so that the frequency-dividing point F4 is located in a frequency band where the phases of both the bone-conducted sound wave and the air-conducted sound wave are stable. For example, a difference between the third resonant frequency F3 and the frequency-dividing point F4 is not less than 500 Hz. In some embodiments, to make the frequency-dividing point F4 located in a frequency band where phases of the bone-conducted sound wave and the air-conducted sound wave are more stable (e.g., the phase difference between the bone-conducted sound wave and the air-conducted sound wave is less than 20 degrees), the difference between the third resonant frequency F3 and the frequency-dividing point F4 is not less than 550 Hz. In some embodiments, to make the frequency-dividing point F4 located in a frequency band where phases of the bone-conducted sound wave and the air-conducted sound wave are particularly stable (e.g., the phase difference between the bone-conducted sound wave and the air-conducted sound wave is less than 10 degrees), the difference between the third resonant frequency F3 and the frequency-dividing point F4 is not less than 600 Hz. In some embodiments, to more easily maintain the bone-conducted sound wave and the air-conducted sound wave in phase, the difference between the third resonant frequency F3 and the frequency-dividing point F4 is not less than 650 Hz.

The phase of the air-conducted sound wave near the third resonant frequency has a certain stable frequency band. In some embodiments of the present disclosure, by limiting the difference between the third resonant frequency and the frequency-dividing point to be not less than 500 Hz, it is beneficial to ensure that the phase of the sound wave in the frequency band near the frequency-dividing point is in a relatively stable range. Furthermore, it can avoid differences in the phase of the bone-conducted sound wave and the air-conducted sound wave in the frequency band near the frequency-dividing point corresponding to different batches of devices due to fluctuations in the resonant frequencies of the bone conduction vibrator and/or the air conduction vibrator caused by differences in the preparation process among different batches of devices. This ensures the output performance of the acoustic output device and improves the output stability of the prepared acoustic output devices.

As shown in FIG. 6, since the phase of the air-conducted sound wave gradually increases with increasing frequency in a frequency range before the third resonant frequency F3, there is a relatively obvious difference between the phase of the air-conducted sound wave in the stable phase interval and the phase at the third resonant frequency F3. In some embodiments, when the frequency-dividing point F4 is located in a frequency band where the phase of the air-conducted sound wave is stable, a difference between the phase of the air-conducted sound wave at the frequency-dividing point F4 and the phase of the air-conducted sound wave at the third resonant frequency F3 may be greater than 20°. In some embodiments, to make the frequency-dividing point F4 located in a frequency band where the phases of both the bone-conducted sound wave and the air-conducted sound wave are more stable, the difference between the phase of the air-conducted sound wave at the frequency-dividing point F4 and the phase of the air-conducted sound wave at the third resonant frequency F3 may be greater than 30°. In some embodiments, to make the frequency-dividing point F4 located in a frequency band where the phases of both the bone-conducted sound wave and the air-conducted sound wave are more stable, the difference between the phase of the air-conducted sound wave at the frequency-dividing point F4 and the phase of the air-conducted sound wave at the third resonant frequency F3 may be greater than 50°.

In some embodiments, as shown in FIG. 8, when the phases of the first audio signal and the second audio signal are close, the phase of the bone-conducted sound wave output by the bone conduction vibrator 11 and the phase of the air-conducted sound wave output by the air conduction vibrator 12 are close. At this point, to achieve "superposition" of the bone-conducted sound wave and the air-conducted sound wave to produce an in-phase reinforcement effect, at the frequency-dividing point, a phase difference between the first audio signal and the second audio signal may not exceed 30°. In some embodiments, to better achieve "superposition" of the bone-conducted sound wave and the air-conducted sound wave, at the frequency-dividing point, the phase difference between the first audio signal and the second audio signal may not exceed 20°, or may not exceed 10°.

In some embodiments, as shown in FIG. 8, when the phases of the first audio signal and the second audio signal are close, a phase difference between the bone-conducted sound wave output by the bone conduction vibrator 11 and the air-conducted sound wave output by the air conduction vibrator 12 may be close to 180°. At this point, to achieve "superposition" of the bone-conducted sound wave and the air-conducted sound wave to produce an in-phase reinforcement effect, at the frequency-dividing point, the phase difference between the first audio signal and the second audio signal may be in a range of 150°-210°, for example, the phase difference between the first audio signal and the second audio signal may be 210°, 200°, 190°, 180°, 170°, 160°, 150°, etc.

It should be understood that the frequency values of the frequency-dividing point, the first resonant frequency, and the second resonant frequency involved in various embodiments of the present disclosure may be applied individually or in combination based on the purpose and scenario of the setting, without violating the principles. Embodiments involving individual applications or combined applications are all within the scope disclosed in the present disclosure. For example, since the phase of the bone-conducted sound wave fluctuates significantly before the first resonant frequency, and/or the phase of the air-conducted sound wave fluctuates significantly before the second resonant frequency, therefore, to ensure that the phases of the bone-conducted sound wave and the air-conducted sound wave are relatively stable when the frequency-dividing point is in a relatively low frequency band (e.g., 300 Hz-1000 Hz), thereby ensuring good acoustic output effect of the acoustic output device in this relatively low frequency band, the frequency-dividing point may be greater than the first resonant frequency and the second resonant frequency, i.e., the frequency-dividing point may be greater than a larger one of the first resonant frequency and the second resonant frequency. As another example, since the first one of high-frequency resonant frequencies of the bone conduction vibrator is greater than the first one of high-frequency resonant frequencies of the air conduction vibrator (i.e., the third resonant frequency), and the phase of the air-conducted sound wave fluctuates significantly after the third resonant frequency, therefore, to ensure that the phases of the bone-conducted sound wave and the air-conducted sound wave are relatively stable when the frequency-dividing point is in a relatively high frequency band (e.g., 2500 Hz-5000 Hz), thereby ensuring good acoustic output effect of the acoustic output device in this relatively high frequency band, the frequency-dividing point may be less than the third resonant frequency. As yet another example, since the phase of the bone-conducted sound wave is stable between the first resonant frequency and its first one of high-frequency resonant frequencies, the phase of the air-conducted sound wave is stable between the second resonant frequency and the third resonant frequency, and the first one of high-frequency resonant frequencies of the bone conduction vibrator is greater than the third resonant frequency of the air conduction vibrator, therefore, to ensure that the phases of the bone-conducted sound wave and the air-conducted sound wave are relatively stable when the frequency-dividing point is in a frequency band sensitive to the human ear (e.g., 300 Hz-3500 Hz), thereby ensuring good acoustic output performance of the acoustic output device in the frequency band sensitive to the human ear, the frequency-dividing point may be set within a frequency range between the second resonant frequency or the first resonant frequency and the third resonant frequency.

The basic concepts have been described above. Obviously, to those skilled in the art, the above detailed disclosure is merely an example and does not constitute a limitation on the present disclosure. Although not explicitly stated herein, those skilled in the art may make various modifications, improvements, and amendments to the present disclosure. Such modifications, improvements, and amendments are suggested in the present disclosure, so they still fall within the spirit and scope of the exemplary embodiments of the present disclosure.

What is claimed is:

1. An acoustic output device, comprising:
a housing;
a bone conduction vibrator configured to generate a bone-conducted sound wave, the bone-conducted sound wave being transmitted to a cochlea via the housing to generate sound;
an air conduction vibrator configured to generate an air-conducted sound wave, the air-conducted sound wave being transmitted to an ear via a sound guiding hole on the housing; and
a signal processing module configured to respectively provide a first audio signal and a second audio signal to the bone conduction vibrator and the air conduction vibrator, wherein the first audio signal and the second audio signal have a frequency-dividing point, and the first audio signal includes components with frequencies above the frequency-dividing point, and the second audio signal includes components with frequencies below the frequency-dividing point, wherein,
the bone conduction vibrator has a first resonance peak at a first resonant frequency,
the air conduction vibrator has a second resonance peak at a second resonant frequency, and
the frequency-dividing point is greater than the first resonant frequency and the second resonant frequency.

2. The acoustic output device according to claim 1, wherein the first resonant frequency is located between the second resonant frequency and the frequency-dividing point.

3. The acoustic output device according to claim 1, wherein a difference between the first resonant frequency and the frequency-dividing point and a difference between the second resonant frequency and the frequency-dividing point are each not less than 100 Hz.

4. The acoustic output device according to claim 1, wherein at the frequency-dividing point, a phase difference between the first audio signal and the second audio signal does not exceed 30°.

5. The acoustic output device according to claim 1, wherein the frequency-dividing point is not less than 300 Hz.

6. The acoustic output device according to claim 5, wherein the housing includes two sound guiding holes configured to output the air-conducted sound wave,
an amplitude difference between sounds radiated through the two sound guiding holes is less than 6 dB, and
a phase difference between the sounds radiated through the two sound guiding holes is in a range of 150°-210°.

7. The acoustic output device according to claim 6, wherein a difference between acoustic loads of the two sound guiding holes is less than 0.15.

8. The acoustic output device according to claim 6, wherein a ratio of surface acoustic loads of the two sound guiding holes is 0.5-3.5.

9. The acoustic output device according to claim 1, wherein the air conduction vibrator has a front cavity or a rear cavity,
the front cavity or the rear cavity forms a third resonance peak having a third resonant frequency, and
the frequency-dividing point is less than the third resonant frequency.

10. The acoustic output device according to claim 9, wherein a difference between the third resonant frequency and the frequency-dividing point is not less than 500 Hz.

11. The acoustic output device according to claim 9, wherein the frequency-dividing point is not higher than 3000 Hz.

12. The acoustic output device according to claim 1, wherein the signal processing module performs high-pass filtering and low-pass filtering respectively on an electrical signal containing sound information to obtain the first audio signal and the second audio signal.

13. An acoustic output device, comprising:
a housing;
a bone conduction vibrator configured to generate a bone-conducted sound wave, the bone-conducted sound wave being transmitted to a cochlea via the housing to generate sound;
an air conduction vibrator configured to generate an air-conducted sound wave, the air-conducted sound wave being transmitted to an ear via a sound guiding hole on the housing;
a signal processing module configured to respectively provide a first audio signal and a second audio signal to the bone conduction vibrator and the air conduction vibrator, wherein the first audio signal and the second audio signal have a frequency-dividing point, and the first audio signal includes components with frequencies above the frequency-dividing point, and the second audio signal includes components with frequencies below the frequency-dividing point, wherein,
the air conduction vibrator has a front cavity or a rear cavity,
the front cavity or the rear cavity forms a third resonance peak having a third resonant frequency, and
the frequency-dividing point is less than the third resonant frequency.

14. The acoustic output device according to claim 13, wherein a difference between the third resonant frequency and the frequency-dividing point is not less than 500 Hz.

15. The acoustic output device according to claim 13, wherein the frequency-dividing point is not higher than 3000 Hz.

16. The acoustic output device according to claim 13, wherein the frequency-dividing point is not less than 300 Hz.

17. The acoustic output device according to claim 16, wherein the housing includes two sound guiding holes configured to output the air-conducted sound wave,
an amplitude difference between sounds radiated through the two sound guiding holes is less than 6 dB, and
a phase difference between the sounds radiated through the two sound guiding holes is in a range of 150°-210°.

18. The acoustic output device according to claim 17, wherein a difference between acoustic loads of the two sound guiding holes is less than 0.15.

19. The acoustic output device according to claim 17, wherein a ratio of surface acoustic loads of the two sound guiding holes is 0.5-3.5.

20. The acoustic output device according to claim 13, wherein the signal processing module performs high-pass filtering and low-pass filtering respectively on an electrical signal containing sound information to obtain the first audio signal and the second audio signal.
